(19) United States
(12) Patent Application Publication
(10) Pub. No.: US 2026/0333146 A1
(43) Pub. Date: Oct. 22, 2026

(54) INDICATION INFORMATION PROCESSING METHOD AND DEVICE

(71) Applicant: Spreadtrum Communications (Shanghai) Co., Ltd., Shanghai (CN)

(72) Inventors: Huayu ZHOU, Shanghai (CN); Zhengang PAN, Shanghai (CN)

(21) Appl. No.: 19/103,479

(22) PCT Filed: Aug. 11, 2023
(86) PCT No.: PCT/CN2023/112713

§ 371 Date: Feb. 12, 2025

(30) Foreign Application Priority Data
Aug. 12, 2022 (CN) 202210971914.7

(51) Int. Cl. H04W 36/00; H04L 5/00; H04W 74/0833

(52) U.S. Cl. CPC H04W 36/0072; H04L 5/0096; H04W 74/0833

(57) ABSTRACT

The present disclosure provides an indication information processing method, and relates to the field of communication technology, the method includes: based on indication information, determining a state of a SSB, and/or determining a state of a random access resource for uplink synchronization.

### CROSS-REFERENCE TO RELATED APPLICATIONS

This application is a National Stage of International Application No. PCT/CN2023/112713, filed on Aug. 11, 2023, which claims priority to Chinese Patent Application No. 202210971914.7, filed on Aug. 12, 2022, both of which are hereby incorporated by reference in their entireties.

### TECHNICAL FIELD

The present disclosure relates to the field of communication technology and, in particular, to an indication information processing method and a device.

### BACKGROUND

With the continuous expansion of the scale of communication network, the power consumption of communication network is also increasing. In order to reduce operating costs, various energy-saving measures have been adopted in related art to reduce the power consumption of the communication network.

For example, in the 5th generation mobile communication technology (5G) network, due to more spectrum resources, when network load is low, cells corresponding to some frequency bands can choose to be turned off and on as needed, so as to achieve a purpose of network energy saving. A cell that can be turned on/off as needed can be called a switching target cell; correspondingly, a cell that is not turned off can be called a current cell.

### SUMMARY

The present disclosure provides an indication information processing method and a device.

In a first aspect, an embodiment of the present disclosure provides an indication information processing method, where the method includes:
based on indication information, determining a state of a synchronization signal block (SSB), and/or determining a state of a random access resource for uplink synchronization.

In a second aspect, an embodiment of the present disclosure provides an indication information processing method, where the method includes:
based on indication information, determining an index or identification information of a bandwidth part (BWP) activated in a switching target cell.

In a third aspect, an embodiment of the present disclosure provides an indication information processing method, where the method includes:
configuring indication information, where the indication information is used by a terminal device to determine a state of a SSB and/or determine a state of a random access resource for uplink synchronization.

In a fourth aspect, an embodiment of the present application provides a computer readable storage medium, where the computer readable storage medium stores computer-executed instructions, when a computer executes the computer-executed instructions, the indication information processing method described in the first or second or third aspect is implemented.

### BRIEF DESCRIPTION OF DRAWINGS

FIG. 1 is an architecture diagram of a wireless communication system provided by an embodiment of the present disclosure.

FIG. 2 is a flow diagram of an indication information processing method provided by an embodiment of the present disclosure.

FIG. 3 is a flow diagram of another indication information processing method provided by an embodiment of the present disclosure.

FIG. 4 is a flow diagram of another indication information processing method provided by an embodiment of the present disclosure.

FIG. 5 is a schematic diagram of a hardware structure of an electronic device provided by an embodiment of the present disclosure.

### DESCRIPTION OF EMBODIMENTS

In order to make a purpose, technical solution and advantages of embodiments of the present disclosure more clear, the technical solution in the embodiments of the present disclosure will be clearly and completely described in combination with the drawings attached to the embodiments of the present disclosure. Obviously, the embodiments described are part of the embodiments of the present disclosure, but not all embodiments. All other embodiments obtained based on the embodiments in the present disclosure by ordinary skilled persons in the field without creative labor are within the protection scope of the present disclosure. In addition, although disclosures in the present disclosure are presented in terms of one or multiple exemplary examples, it should be understood that aspects of these disclosures may individually constitute a complete implementation.

It should be noted that the brief description of terms in the present disclosure is intended only to facilitate understanding of implementations described below and is not intended to limit the implementations of the present disclosure. Unless otherwise stated, these terms should be understood in their ordinary and usual meaning.

The terms “first”, “second”, “third”, etc. in the description and claims and the drawings attached above in the present disclosure are used to distinguish similar or same objects or entities and are not necessarily intended to define a particular order or sequence, unless otherwise indicated. It should be understood that the terms so used are interchangeable where appropriate. For example, an order other than those given in the illustration or description of the embodiments of the present disclosure may be implemented.

In addition, the terms “including” and “having”, and any variants thereof, are intended to cover a non-exclusive inclusion. For example, products or devices including a range of components need not be limited to those components that are clearly listed, but may include other components that are not clearly listed or are inherent to those products or devices.

It should be understood that the term “and/or” used herein is merely to describe an association relationship between associated objects, indicating that there can be three kinds of relations. For example, A and/or B, can mean: A exists alone, A and B exist simultaneously, and B exists alone. In addition, the character “/” herein generally means that the associated objects are in an “or” relationship.

The embodiments of the present disclosure can be applied to various communication systems, such as: advanced long term evolution (LTE-A) systems, new radio (NR) systems, evolution systems of NR systems, LTE-based access to unlicensed spectrum (LTE-U) systems, NR-based access to unlicensed spectrum (NR-U) systems, universal mobile telecommunication systems (UMTS), wireless local area networks (WLAN), wireless fidelity (WiFi), next generation communication systems or other communication systems.

Generally, some communication systems support a limited number of connections and are easy to implement, however, with the development of communication technology, mobile communication systems will not only support some communication, but also support, for example, device to device (D2D) communication, machine to machine (M2M) communication, machine type communication (MTC), and vehicle-to-vehicle (V2V) communication, etc. The embodiments of the present disclosure may also be applied to these communication systems.

Alternatively, the communication system in the embodiments of the present disclosure can be applied to a carrier aggregation (CA) scenario, or dual connectivity (DC) scenario, or standalone (SA) networking scenario.

The embodiments of the present disclosure do not impose limitation on application spectrum. For example, an embodiment of the present disclosure can be applied to licensed spectrum or unlicensed spectrum.

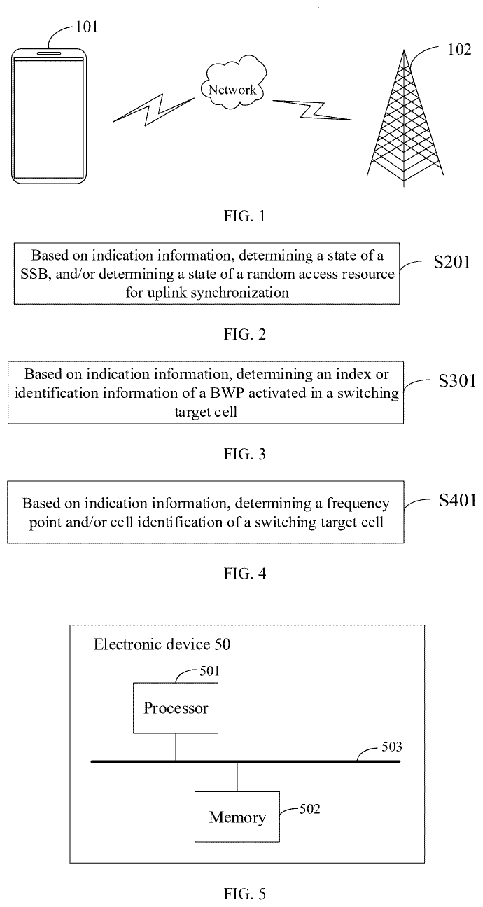

Refer to FIG. 1. FIG. 1 is an architecture diagram of a wireless communication system provided by an embodiment of the present disclosure. The wireless communication system provided by the embodiment includes a terminal device 101 and a network device 102.

Optionally, the terminal device 101 can be any form of user equipment (UE), access terminal, user unit, user station, mobile site, mobile station (MS), remote station, remote terminal, mobile device, wireless communication device, user agent, or user apparatus. It can also be a cellular phone, cordless phone, session initiation protocol (SIP) phone, wireless local loop (WLL) stations, personal digital assistant (PDA), hand-held device with wireless communication capabilities, computing device or other processing devices connected to wireless modems, vehicle-mounted device, wearable device, terminal device in the future 5G network or terminal device in the future evolved public land mobile network (PLMN), etc. This is not limited in the embodiments of the present disclosure, as long as the terminal can communicate wirelessly with the network device 102.

Optionally, the network device 102, i.e., a public mobile communication network device, is an interface device for the terminal device 101 to access the Internet, and is also a form of radio station, which refers to a radio transceiver station that communicates information with the terminal device 101 in a certain radio coverage area, including base station (BS), also known as a base station device, which is an apparatus deployed on a radio access network (RAN) to provide wireless communication function. For example, a device that provides base station function in 2G network includes base transceiver station (BTS); a device that provides the base station function in 3G network includes NodeB; a device that provides the base station function in 4G network includes evolved NodeB (eNB); a device that provides base station function in wireless local area networks (WLAN) is an access point (AP); a device that provides base station function in 5G NR is the next generation NodeB (gNB) and the next generation-eNodeb (ng-eNB). NR technology is adopted for the communication between the gNB and terminals, and evolved universal terrestrial radio access (E-UTRA) technology is adopted for the communication between ng-eNB and the terminals. Both the gNB and ng-eNB can connect to 5G core network. The network device 102 in the embodiments of the present disclosure also includes devices providing base station functions in a future new communication system.

Network energy saving (or network power saving) is a concern for operators and device manufacturer. The network energy saving is very beneficial for reducing operating costs (economic) and green environmental protection (low-carbon). In the 5G network, due to a large number of spectrum resources, for example, bands such as 1 GHz, 2 GHz, 4 GHz, 6 GHz and 26 GHz, when the network load is low, carriers or cells corresponding to some frequency bands (such as 4 GHz, 6 GHz or 26 GHz, etc.) can be turned off as far as possible and turned on as needed, so as to achieve a purpose of network energy saving. That is, when the network load is low, some carriers or cells do not need to carry data and do not need to send a common signal and/or channel. Generally, the purpose of network energy saving can be achieved through the turning on and off of certain carriers or cells, but this is generally achieved only when the network load is low.

The carrier or cell that can be turned on/off as needed can be called a non-anchor carrier or a non-anchor cell, or be called a switching target carrier or a switching target cell. Correspondingly, a carrier or cell that is not turned off can be called an anchor carrier or an anchor cell, or be called a current carrier or a current cell.

In a CA or DC scenario, there are two ways to understand the anchor cell and the non-anchor cell.

Way 1: the anchor cell is a primary carrier or primary carrier component or a primary cell (PCell) or a primary secondary cell (PSCell), that is, a carrier or cell that mainly carries control signaling. A non-anchor cell is usually a secondary carrier or secondary carrier component or secondary cell (SCell), that is, a carrier or cell that mainly carries data. At this time, the turning on and off of the non-anchor cell can be understood as addition, deletion or modification of the secondary cell. In this way, the requirement of backhaul network between the anchor cell and the non-anchor cell is higher, but the turning on and off of the non-anchor cell is easier to achieve (by addition, deletion or modification of the secondary cell).

Way 2: both the anchor cell and the non-anchor cell are the primary carrier or the primary carrier component or the primary cell or the primary secondary cell, that is, the carrier or cell that mainly carries the control signaling. At this time, the turning on of the non-anchor cell can be a switch from the anchor cell to the non-anchor cell, and the turning off of the non-anchor cell can be understood as a switch from the non-anchor cell to the anchor cell. In this way, the requirement of the backhaul network between the anchor cell and the non-anchor cell is lower, but the complexity of the turning on and off of the non-anchor cell is higher.

In a non-CA/DC scenario, similar to way 2 in CA/DC, the turning on of the non-anchor cell can be understood as the switch from the anchor cell to the non-anchor cell, and the turning off of the non-anchor cell can be the switch from the non-anchor cell to the anchor cell. At this time, the requirement of the backhaul network between the anchor cell and the non-anchor cell is lower, but the complexity of the turning on and off of the non-anchor cell is higher.

The SSB can be used by the UE to perform time-frequency synchronization and acquire a master information block (MIB) and a system information block (SIB). For the non-anchor carrier or non-anchor cell, they are only used for a purpose of data load balancing and do not need to carry MIB, so the synchronization signal block (burst) can be simplified. In contrast, the anchor carrier or anchor cell needs to carry MIB and SIB to support cell search and system information transmission. The non-anchor carrier or the non-anchor cell may still need to support paging, random access, and radio resource management (RRM) measurements, etc., and therefore still need to carry synchronization signal blocks to support the user equipment for time/frequency synchronization (time/frequency tracking) and RRM measurement.

In general, the non-anchor cell is controlled by the network and is turned on and off as needed. When the non-anchor cell and the anchor cell belong to the same base station (such as CA scenario), the base station can turn on or off the non-anchor cell as needed. When the non-anchor cell and the anchor cell do not belong to the same base station, a base station of the anchor cell can make a base station of the non-anchor cell to turn on or off the non-anchor cell as needed through inter-base station signaling, or the base station of the non-anchor cell can turn on or off the non-anchor cell as needed based on the core network command or signal/load requirement.

In general, a process of turning on the non-anchor cell as needed is divided into the following two cases.

Case 1, the time to turn on the non-anchor cell can be before the UE completes the random access (RA). This allows the UE to use the resources of the non-anchor cell as quickly as possible (allowing the non-anchor cell to provide more load balancing) and reduces signaling overhead of performing a handover (HO) on the connected state. A process of the random access is generally divided into four steps, respectively corresponding to the four channels or messages of random access channel. The random access channel includes: PRACH, also known as message 1 (Msg1); random access response (RAR), also known as message 2 (Msg2); message 3 (Msg3); message 4 (Msg4) etc. The time to turn on the non-anchor cell can be before the UE initiates the random access, that is, before the UE sends PRACH. In this way, the UE can initiate a process of the random access or the random access channel (RACH) on the non-anchor cell, and use PRACH resource on the non-anchor cell. The time to turning on the non-anchor cell can also be after the UE initiates the random access and before the UE completes random access, for example, before the UE sends message 3. In this way, UE can transfer to the non-anchor cell as soon as possible after initiating the random access on the anchor cell.

Case 2, the time to turn on the non-anchor cell can be after the UE completes the random access, that is, after the UE completes the initial access or after the UE enters the connected state. In this way, the non-anchor cell can only serve the UE which is in the connected state, duration for which the non-anchor cell is turned off is increased, and energy saving gain of the non-anchor cell is increased.

As case 2 above, when in the connected state, the UE can switch from the anchor cell to the non-anchor cell, that is, the primary cell switches from the anchor cell to non-anchor cell. At this time, following problems need to be solved:
problem 1: a problem about uplink synchronization.

When the anchor cell and the non-anchor cell are not synchronized, for example, when the anchor cell and the non-anchor cell belong to different base stations (such as way 2 in the aforementioned CA/DC or non-CA/DC), or the anchor cell and the non-anchor cell belong to the same base station but antenna distance between the two is far away (resulting in a large difference in propagation delay), before switching to the non-anchor cell for data receiving and sending, UE needs to establish the uplink synchronization with the non-anchor cell through RA resources. There is a time deviation between signals from (downlink) and/or sent to (uplink) the base station of the anchor cell and the base station of the non-anchor. The time deviation mainly includes a time deviation between the two base stations themselves (such as different base stations), the difference in propagation time caused by the difference in center frequency between the anchor cell and the non-anchor cell, and/or the difference in propagation time caused by the difference in distance between UE and the two base stations. Therefore, it is necessary for UE to establish uplink synchronization with the non-anchor cell.

For uplink synchronization, UE in the connected state should preferably use contention free random access (CFRA) resources to improve the efficiency of establishing uplink synchronization with the non-anchor cell. For uplink synchronization in the anchor cell, because the base station of the anchor cell knows which SSB of the anchor cell is suitable for the UE to use, a method is that the base station indicates a SSB (or beam) and its associated CFRA resource information to the UE. However, for uplink synchronization when switching from the anchor cell to the non-anchor cell, the base station of the anchor cell does not know which SSB of the non-anchor cell is suitable for UE to use. The base station should indicate multiple SSBs and their associated CFRA resource information to the UE. At this time, the base station of the non-anchor cell actually uses a beam sweeping approach to send SSBs and configure their associated CFRA resources. Therefore, how does UE obtain one or multiple SSBs and their associated CFRA resource information is an urgent problem to be solved.

Problem 2: still a problem about uplink synchronization.

For uplink synchronization, when the base station of the anchor cell does not know random access resource configuration of the non-anchor cell, the base station of the anchor cell cannot indicate the CFRA resource to the UE. Accordingly, the UE can only use contention based random access (CBRA) resource. Therefore, how does the UE obtain information about using the CFRA resource or the CBRA resource is also an urgent problem to be solved.

Problem 3: a problem about a bandwidth part.

It is necessary to determine which BWP to use when the UE switches to the non-anchor cell. How does the UE obtain information about which BWP to use on the non-anchor cell is also an urgent problem to be solved.

Problem 4: a problem about the switching target cell.

The UE needs to determine which switching target cell to switch to. How does the UE obtain information of which switching target cell to switch to is also an urgent problem to be solved.

In the face of the above technical problems, an embodiment of the present disclosure provides an indication information processing method.

For problem 1, a base station can use first indication information (for example, 1 bit) to indicate to a UE (available to the UE, even if there are multiple SSBs, it may indicate only one SSB to the UE) whether there is one or multiple SSBs of a non-anchor cell and its associated CFRA resource. When it is indicated that there is one SSB of the non-anchor cell and its associated CFRA resource, a back to a certain usage of PDCCH order is performed.

For problem 2, the base station can use second indication information (for example, another 1 bit) to indicate to the UE whether to use the CFRA resource or the CBRA resource.

For problem 1 and problem 2, there is an association. When the first indication information indicates that there is one SSB of the non-anchor cell and its associated CFRA resource, the second indication information can be not used, because in the certain usage of the PDCCH order, when “Random Access Preamble Index” is all zeros (meaningless), CBRA resource is indicated to the UE to use. That is, when the first indication information indicates that there is one SSB of the non-anchor cell and its associated CFRA resource, the second indication information can be not used. When problem 1 and problem 2 are combined, the first indication information and the second indication information are jointly encoded into third indication information (for example, 2 bits), and 3 states or codepoints are taken. For example, state 1 is that there is one SSB of the non-anchor cell and its associated CFRA resource (back to the certain usage of PDCCH order), state 2 is that there are multiple SSBs of the non-anchor cell and their associated CFRA resources and the CFRA resource is to be used, and state 3 is that there are multiple SSBs of the non-anchor cell and the CBRA resource is to be used. This will save a state for later use.

For problem 3, the base station can use fourth indication information to indicate, to the UE, an index or identification (ID) or number of the BWP used on the non-anchor cell.

For problem 4, the base station can use fifth indication information to indicate, to the UE, a frequency point and/or identification (ID) of a switching target non-anchor cell.

It should be noted that in the embodiments of the present disclosure, the current cell can also be used to represent the anchor cell, and the switching target cell can be used to represent the non-anchor cell. In addition, the handover is equivalent to the switch except for the special explanation “handover”.

Then, detailed embodiments are used to illustrate in detail.

Refer to FIG. 2. FIG. 2 is a flow diagram of an indication information processing method provided by an embodiment of the present disclosure. In some embodiments, the indication information processing method can be applied in a UE.

Optionally, the indication information processing method above can be performed by the UE, or by a chip or a specific module in the UE.

The indication information processing method above includes:
S201, based on indication information, determining a state of a SSB, and/or determining a state of a random access resource for uplink synchronization.

Exemplarily, the state of the SSB includes SSB state 1 or SSB state 2.

The SSB state 1 corresponds to one SSB. When the state of the SSB is SSB state 1, the network device specifically indicates one SSB to the UE. The SSB state 2 corresponds to one or multiple SSBs (not limited to one SSB). When the state of the SSB is SSB state 2, the network device can indicate multiple SSBs to the UE so that the UE can select an appropriate SSB and/or corresponding random access resource. It should be noted that there may be a mapping relationship between the SSB and the random access resource (such as random access preamble and PRACH occasion). The mapping relationship can be either preset or configured. By preset or configured mapping relationship, the random access resource can be indicated only by indicating the SSB, or the SSB can be indicated only by indicating the random access resource, which reduces signaling overhead.

Exemplarily, the state of the random access resource includes random access resource state 1 or random access resource state 2. The random access resource state 1 corresponds to the CFRA resource. When the state of the random access resource is the random access resource state 1, the network device specifically indicates the CFRA resource to UE. The random access resource state 2 corresponds to the CBRA resource. When the state of the random access resource is the random access resource state 2, the network device can indicate the CBRA resource to the UE, so that the UE can select an appropriate random access preamble and PRACH occasion.

Specifically, a CFRA resource includes a set of PRACH occasions and a set of random access preambles, and the set of PRACH occasions and the set of random access preambles correspond to a set of SSBs. Or, a CFRA resource includes a set of SSBs, a set of PRACH occasions, and a set of random access preambles. A PRACH occasion is a time-frequency resource of the PRACH. When one SSB corresponds to multiple PRACH occasions, a PRACH mask can indicate one of the PRACH occasions. The PRACH occasion can also be called the PRACH mask. In general, the PRACH occasion can be represented by a PRACH mask index, the random access preamble can be represented by a random access preamble index, and the SSB can be represented by a SSB index. It should be understood that the term “a set of” here includes both “one” and “multiple”. A CFRA resource can represent one CFRA resource or multiple CFRA resources unless otherwise specified. In general, one random access preamble in one CFRA resource corresponds to one SSB. One PRACH occasion in one CFRA resource corresponds to a set of SSBs.

Specifically, a CBRA resource includes a set of PRACH occasions and a set of random access preambles, and the set of PRACH occasions and the set of random access preambles have a preset or configured mapping relationship with the SSB. It should be understood that the SSB here can be a SSB that is actually sent. CBRA resource configuration does not include SSB configuration due to the preset or configured mapping relationship. It should be understood that the term “a set of” here includes both “one” and “multiple”. A CBRA resource can represent one CBRA resource or multiple CBRA resources unless otherwise specified.

In a feasible implementation, the indication information above can be carried by any one of the PDCCH order, GC-PDCCH, or MAC-CE.

Exemplarily, in some implementations, the indication information above can be carried by the PDCCH order, so that the PDCCH order signaling can be reused, saving signaling overhead and reducing the complexity.

In some implementations, the indication information above can be carried by the GC-PDCCH. By using the GC-PDCCH, the first indication information above can be sent to a set of UEs at the same time, thus saving the signaling overhead.

In some implementations, the indication information above can be carried by the MAC-CE. By using MAC-CE to carry, the UE can feedback whether the PDSCH has been successfully decoded (via HARQ-ACK signaling), thereby avoiding misunderstandings between the base station and the UE and reducing latency.

Based on the indication information above, the UE can determine the state of the SSB and/or determine the state of the random access resource for uplink synchronization.

Exemplarily, the UE can obtain different information based on the indication information above to deal with the following different scenarios:
one SSB and its corresponding CFRA resource;
multiple SSBs and their corresponding CFRA resources;
one SSB and using the CBRA resource (when the CBRA resource has been configured, the random access resource can need not to be indicated);
multiple SSBs and using the CBRA resource (when the CBRA resource has been configured, the random access resource can need not to be indicated).

In the indication information processing method provided by the present disclosure, based on the indication information, the UE can determine the state of the SSB and/or determine the state of the random access resource, so as to help the UE cope with various uplink synchronization scenarios.

Based on the description in the above embodiments, in some embodiments of the present disclosure, the indication information above is the first indication information; based on the first indication information, the UE can determine that the state of the SSB is SSB state 1 or SSB state 2.

The SSB state 1 corresponds to one SSB, and the SSB state 2 corresponds to one or multiple SSBs (not limited to one SSB).

For example, the base station can use the first indication information above to indicate to the UE that there are one or multiple SSBs of the non-anchor cell and its associated CFRA resources, thus solving the above “problem 1”.

Optionally, the first indication information above can be of 1 bit, which saves bit overhead.

In some implementations, the first indication information above can be carried by the PDCCH order, so that the PDCCH order signaling can be reused, saving signaling overhead and reducing the complexity.

In some embodiments, the first indication information above can be carried by the GC-PDCCH. By using the GC-PDCCH, the first indication information above can be sent to a set of UEs at the same time, thus saving the signaling overhead.

In some embodiments, the first indication information above can be carried by the MAC-CE. By using MAC-CE to carry, the UE can feedback whether the PDSCH has been successfully decoded (via HARQ-ACK signaling), thereby avoiding misunderstandings between the base station and the UE and reducing latency.

In some embodiments, when the first indication information above indicates that the state of the SSB is SSB state 1, the field of the PDCCH order is not escaped.

When the first indication information above indicates that the state of the SSB is SSB state 2, the field of PDCCH order is escaped.

When the first indication information above indicates that the state of the SSB is SSB state 2, “SSB index”, “random access preamble index”, and “PRACH mask index” in the PDCCH order no longer take effect (or are reserved). This way, when the first indication information above indicates that the state of the SSB is SSB state 2, the field that is no longer needed can be escaped to a new field.

Based on the description in the above embodiments, in some embodiments of the present disclosure, the indication information above is the second indication information. Based on the second indication information, the UE can determine that the state of the random access resource is random access resource state 1 or random access resource state 2.

The random access resource state 1 corresponds to CFRA resource, and random access resource state 2 corresponds to the CBRA resource.

For example, the base station can use the second indication information above to indicate to the UE whether to use the CFRA resource or the CBRA resource, thus the “problem 2” above can be solved.

It can be understood that when the first indication information indicates that the state of the SSB is SSB state 1, the UE may not parse the second indication information, because the field of the PDCCH order is not escaped at this time. There are ways to indicate whether to use the CFRA resource or the CBRA resource (the field of the “random access preamble index” is all zeros).

Optionally, the second indication information above can be of 1 bit, which saves bit overhead.

In some implementations, the second indication information above can be carried by the PDCCH order, so that the PDCCH order signaling can be reused, saving signaling overhead and reducing the complexity.

In some embodiments, the second indication information above can be carried by the GC-PDCCH. By using the GC-PDCCH, the first indication information above can be sent to a set of UEs at the same time, thus saving the signaling overhead.

In some embodiments, the second indication information above can be carried by the MAC-CE. By using MAC-CE to carry, the UE can feedback whether the PDSCH has been successfully decoded (via HARQ-ACK signaling), thereby avoiding misunderstandings between the base station and the UE and reducing latency.

In some embodiments, it can be understood that when the base station indicates the UE to use the CBRA resource, the UE does not use the CFRA resource associated with the indicated SSB of the non-anchor cell, but only the CBRA resource associated with the indicated SSB of the non-anchor cell.

Based on the description in the above embodiments, in some embodiments of the present disclosure, the indication information above is the third indication information; Based on the third indication information, the UE can determine that the state of the SSB is SSB state 1 or SSB state 2, and determine that the state of the random access resource is random access resource state 1 or random access resource state 2.

The SSB state 1 corresponds to one SSB, and the SSB state 2 corresponds to one or multiple SSBs (not limited to one SSB). The random access resource state 1 corresponds to CFRA resource, and random access resource state 2 corresponds to the CBRA resource.

When the first indication information indicates that there is one SSB of the non-anchor cell, the second indication information can be not used, because in the certain usage of the PDCCH order, when “Random Access Preamble Index” is all zeros (meaningless), CBRA resource is indicated to the UE to use. That is, when the first indication information indicates that there is one SSB of the non-anchor cell, the second indication information can be not used. This means that the first indication information and the second indication information can be jointly encoded into the third indication information to solve both “problem 1” and “problem 2”.

Optionally, the third indication information above can be of 2 bits, which saves bit overhead.

Optionally, the third indication information can include 3 states or codepoints. In this way, one state can be saved for later use, thus improving the forward compatibility and reducing the flexibility of the system.

The above third indication information can indicate the following states:
state 1: indicating SSB state 1;
state 2: indicating SSB state 2 and random access resource state 1;
state 3: indicating SSB state 2 and random access resource state 2.

In some embodiments, the state 1 above is that there is one SSB of the non-anchor cell and its associated CFRA resource (back to the certain usage of the PDCCH order), the state 2 above is that there are multiple SSBs of the non-anchor cell and its associated CFRA resource and the CFRA resource is to be used, and the state 3 is that there is one or multiple SSBs of the non-anchor cell and the CBRA resource is to be used.

Optionally, the third indication information above can be carried by the PDCCH order, so that the PDCCH order signaling can be reused, saving signaling overhead and reducing the complexity.

In some implementations, the third indication information above can be carried by the GC-PDCCH. By using the GC-PDCCH, the first indication information above can be sent to a set of UEs at the same time, thus saving the signaling overhead.

In some implementations, the third indication information above can be carried by the MAC-CE. By using MAC-CE to carry, the UE can feedback whether the PDSCH has been successfully decoded (via HARQ-ACK signaling), thereby avoiding misunderstandings between the base station and the UE and reducing latency.

The indication information processing method provided by the embodiment of the present disclosure can include most scenarios, that is, scenarios that one SSB and its corresponding CFRA resource, multiple SSBs and their corresponding CFRA resources, and one or multiple SSBs and using the CBRA resource (at this time, the random access resource does not need to be indicated).

Refer to FIG. 3. FIG. 3 is a flow diagram of another indication information processing method provided by an embodiment of the present disclosure. In some embodiments, the indication information processing method can be applied in the UE.

Optionally, the indication information processing method above can be performed by the UE, or by a chip or a specific module in the UE.

The indication information processing method above includes:
S301, based on indication information, determining an index or identification information of a BWP activated in a switching target cell.

In some embodiments, the indication information above can also be referred to as fourth indication information and can be used to determine the index or identification or number of an activated BWP.

Exemplarily, the base station can use the fourth indication information above to indicate to the UE the index or identification or number of the (activated) BWP used on the non-anchor cell to solve the “problem 3” above.

Optionally, the fourth indication information above can be carried by any one of the PDCCH order, GC-PDCCH, or MAC-CE.

Optionally, the fourth indication information above can be of 2 bits to save bit overhead.

In some implementations, the fourth indication information above can be carried by the PDCCH order, so that the PDCCH order signaling can be reused, saving signaling overhead and reducing the complexity.

In some implementations, the fourth indication information above can be carried by the GC-PDCCH. By using the GC-PDCCH, the first indication information above can be sent to a set of UEs at the same time, thus saving the signaling overhead.

In some implementations, the fourth indication information above can be carried by the MAC-CE. By using MAC-CE to carry, the UE can feedback whether the PDSCH has been successfully decoded (via HARQ-ACK signaling), thereby avoiding misunderstandings between the base station and the UE and reducing latency.

According to the indication information processing method provided by the present disclosure, the UE can determine, based on the indication information, the index or identification information of the BWP activated in the switching target cell, so that when the UE switches from the current cell to the switching target cell, it can obtain the information of which BWP is to be used in the switching target cell.

Refer to FIG. 4. FIG. 4 is a flow diagram of another indication information processing method provided by an embodiment of the present disclosure. In some embodiments, the indication information processing method can be applied in a UE.

Optionally, the indication information processing method above can be performed by the UE, or by a chip or a specific module in the UE.

The indication information processing method above includes:
S401, based on indication information, determining a frequency point and/or cell identification of a switching target cell.

In some embodiments, the indication information above can also be referred to as fifth indication information and can be used to determine the frequency point and/or the cell identification of the switching target cell to solve the “problem 4” above.

Optionally, the fifth indication information above can be carried by any one of the PDCCH order, GC-PDCCH, or MAC-CE.

Exemplarily, the base station may use the fifth indication information above to indicate a switching target non-anchor cell to the UE, where the target non-anchor cell can be determined by the cell frequency and/or cell identification (ID).

Optionally, the cell identification can be a physical cell identification (PCI).

Optionally, the fifth indication information above can be of 2 bits, which saves bit overhead.

In some implementations, the fifth indication information above is carried by the PDCCH order, so that the PDCCH order signaling can be reused, saving signaling overhead and reducing the complexity.

In some implementations, the fifth indication information above can be carried by the GC-PDCCH. By using the GC-PDCCH, the first indication information above can be sent to a set of UEs at the same time, thus saving the signaling overhead.

In some implementations, the fifth indication information above can be carried by the MAC-CE. By using MAC-CE to carry, the UE can feedback whether the PDSCH has been successfully decoded (via HARQ-ACK signaling), thereby avoiding misunderstandings between the base station and the UE and reducing latency.

In the indication information processing method provided by the present disclosure, the UE can determine the frequency point and/or cell identification of the switching target cell based on the indication information.

Based on the content described in the above embodiments, the present disclosure also provides an indication information processing method. The indication information processing method can be applied to a network device.

Optionally, the indication information processing method above can be performed by the network device, or by a chip or specific module in the network device. The indication information processing method above includes:
configuring indication information, where the indication information is used by a UE to determine a state of a SSB and/or determine a state of a random access resource for uplink synchronization.

In some embodiments, the indication information is carried by any one of a PDCCH order, a GC-PDCCH, or a MAC-CE.

In some embodiments, the indication information is first indication information, and the first indication information is used to indicate that the state of the SSB is SSB state 1 or SSB state 2.

In some embodiments, a SSB index, a random access preamble index, and a PRACH mask index in the PDCCH order are reserved when the state of the SSB is the SSB state 2.

In some embodiments, the first indication information is of 1 bit.

In some embodiments, the indication information is second indication information, where the second indication information is used to indicate that the state of the random access resource is random access resource state 1 or random access resource state 2.

In some embodiments, the second indication information is of 1 bit.

In some embodiments, the indication information is third indication information, where the third indication information is used to indicate that the state of the SSB is SSB state 1 or SSB state 2, and indicate that the state of the random access resource is random access resource state 1 or random access resource state 2.

In some embodiments, the third indication information includes at least three different codepoints, each used to indicate:
the SSB state 1;
the SSB state 2 and the random access resource state 1;
the SSB state 2 and the random access resource state 2.

In some embodiments, the third indication information is of 2 bits.

Based on the content described in the above embodiments, the present disclosure also provides an indication information processing method. The indication information processing method can be applied to a network device.

Optionally, the indication information processing method above can be performed by the network device, or by a chip or specific module in the network device. The indication information processing method above includes:
configuring indication information, where the indication information is used to indicate, to a UE, an index or identification information of a BWP activated in a switching target cell.

In some embodiments, the indication information is carried by any one of a PDCCH order, a GC-PDCCH, or a MAC-CE.

In some embodiments, the indication information is of 2 bits.

Based on the content described in the above embodiments, the present disclosure also provides an indication information processing method. The indication information processing method can be applied to a network device.

Optionally, the indication information processing method above can be performed by the network device, or by a chip or specific module in the network device. The indication information processing method above includes:
configuring indication information, where the indication information is used to indicate, to a UE, a frequency point and/or cell identification of a switching target cell.

In some embodiments, the indication information is carried by any one of a PDCCH order, a GC-PDCCH, or a MAC-CE.

In some embodiments, the indication information is of 2 bits.

Based on the content described in the above embodiments, an indication information processing apparatus is also provided in an embodiment of the present disclosure, where the indication information processing apparatus includes:
a determination module, configured to: based on the indication information, determine a state of a SSB, and/or determine a state of a random access resource for uplink synchronization.

In some embodiments, the indication information is carried by any one of a PDCCH order, a GC-PDCCH, or a MAC-CE.

In some embodiments, the indication information is first indication information;
the determination module is configured to determine that the state of the SSB is SSB state 1 or SSB state 2 based on the first indication information.

In some embodiments, a SSB index, a random access preamble index, and a PRACH mask index in the PDCCH order are reserved when the state of the SSB is determined to be the SSB state 2.

In some embodiments, the first indication information is of 1 bit.

In some embodiments, the indication information is second indication information;
the determination module is configured to determine, based on the second indication information, that the state of the random access resource is random access resource state 1 or random access resource state 2.

In some embodiments, the second indication information is of 1 bit.

In some embodiments, the indication information is third indication information;
the determination module is configured to, based on the third indication information, determine that the state of the SSB is SSB state 1 or SSB state 2, and determine that the state of the random access resource is random access resource state 1 or random access resource state 2.

In some embodiments, the third indication information includes at least three different codepoints, each used to indicate:
the SSB state 1;
the SSB state 2 and the random access resource state 1;
the SSB state 2 and the random access resource state 2.

In some embodiments, the third indication information is of 2 bits.

Based on the content described in the above embodiments, an indication information processing apparatus is also provided in an embodiment of the present disclosure, where the indication information processing apparatus includes:
a determination module, configured to determine, based on the indication information, an index or identification information of a BWP activated in a switching target cell.

In some embodiments, the indication information is carried by any one of a PDCCH order, a GC-PDCCH, or a MAC-CE.

In some embodiments, the indication information is of 2 bits.

Based on the content described in the above embodiments, an indication information processing apparatus is also provided in an embodiment of the present disclosure, where the indication information processing apparatus includes:
a determination module, configured to determine a frequency point and/or cell identification of a switching target cell based on indication information.

In some embodiments, the indication information is carried by any one of a PDCCH order, a GC-PDCCH, or a MAC-CE.

In some embodiments, the indication information is of 2 bits.

It should be noted that the specific content performed by the determination module in the above embodiments is related to each step performed by the UE in the indication information processing method described in the above embodiments. For specific content, please refer to the content described in the above embodiments and details are not repeated here.

Based on the content described in the above embodiments, an indication information processing apparatus is also provided in an embodiment of the present disclosure, where the indication information processing apparatus includes:
a configuration module, configured to configure indication information, where the indication information is used by a UE to determine a state of a synchronization signal block SSB, and/or a state of a random access resource for uplink synchronization.

In some embodiments, the indication information is carried by any one of a PDCCH order, a GC-PDCCH, or a MAC-CE.

In some embodiments, the indication information is first indication information, and the first indication information is used to indicate that the state of the SSB is SSB state 1 or SSB state 2.

In some embodiments, a SSB index, a random access preamble index, and a PRACH mask index in the PDCCH order are reserved when the state of the SSB is the SSB state 2.

In some embodiments, the first indication information is of 1 bit.

In some embodiments, the indication information is second indication information, where the second indication information is used to indicate that the state of the random access resource is random access resource state 1 or random access resource state 2.

In some embodiments, the second indication information is of 1 bit.

In some embodiments, the indication information is third indication information, where the third indication information is used to indicate that the state of the SSB is SSB state 1 or SSB state 2, and indicate that the state of the random access resource is random access resource state 1 or random access resource state 2.

In some embodiments, the third indication information includes at least three different codepoints, each used to indicate:
the SSB state 1;
the SSB state 2 and the random access resource state 1;
the SSB state 2 and the random access resource state 2.

In some embodiments, the third indication information is of 2 bits.

Based on the content described in the above embodiments, an indication information processing apparatus is also provided in an embodiment of the present disclosure, where the indication information processing apparatus includes:
a configuration module, configured to configure indication information, where the indication information is used to indicate, to a UE, an index or identification information of a bandwidth part BWP activated in a switching target cell.

In some embodiments, the indication information is carried by any one of a PDCCH order, a GC-PDCCH, or a MAC-CE.

In some embodiments, the indication information is of 2 bits.

Based on the content described in the above embodiments, an indication information processing apparatus is also provided in an embodiment of the present disclosure, where the indication information processing apparatus includes:
a configuration module, configured to configure indication information, where the indication information is used to indicate, to a UE, a frequency point and/or cell identification of a switching target cell.

In some embodiments, the indication information is carried by any one of a PDCCH order, a GC-PDCCH, or a MAC-CE.

In some embodiments, the indication information is of 2 bits.

It should be noted that the specific content performed by the configuration module in the above embodiments is related to each step performed by the network device in the indication information processing method described in the above embodiments. For specific content, please refer to the content described in the above embodiments and details are not repeated here.

Optionally, the indication information processing apparatus can be a chip or a chip module, etc.

With respect to the modules contained in the indication information processing apparatus described in the above embodiments, they can be software modules or hardware modules, or they can be partly software modules and partly hardware modules. For example, for each apparatus or product applied to or integrated in a chip, each module contained in it can be implemented by hardware such as circuits, or at least part of the modules can be implemented by software program. The software program runs on an integrated processor inside the chip, and the rest (if any) part of the module can be implemented by hardware such as circuits. For each apparatus or product applied to or integrated in the chip module, each module contained in the chip module can be implemented by hardware such as circuits. Different modules can be located in the same component (such as chip, circuit module, etc.) or different components of the chip module, or at least part of the modules can be implemented by software program, the software program runs on the integrated processor inside the chip module, and the rest (if any) part of the module can be implemented by hardware such as circuit. For each apparatus or product applied to or integrated in the terminal, the modules contained in it can be implemented by hardware such as circuits, different modules can be located in the same component (for example, chip, circuit module, etc.) or different components in the terminal, or at least part of the modules can be implemented by software program, the software program runs on the integrated processor inside the terminal, and the rest (if any) part of the module can be implemented by hardware such as circuit.

Further, based on the contents described in the above embodiments, an embodiment of the present disclosure also provides a user equipment, the user equipment includes at least one processor and a memory; where the memory stores computer-executed instructions; the at least one processor above executes the computer-executed instructions stored in the memory to implement the steps performed on the user equipment side in the above embodiments, and details are not repeated in this embodiment here.

Further, based on the contents described in the above embodiments, an embodiment of the present disclosure also provides a network device, the network device includes at least one processor and a memory; where the memory stores computer-executed instructions; the at least one processor above executes computer-executed instructions stored in the memory to implement the steps performed on the network device side in the above embodiments, and details are not repeated in this embodiment here.

In order to better understand the embodiments of the present disclosure, refer to FIG. 5. FIG. 5 is a schematic diagram of a hardware structure of an electronic device provided by an embodiment of the present disclosure. The electronic device can be the user equipment or the network device mentioned above.

As shown in FIG. 5, the electronic device 50 of the embodiment includes: a processor 501 and a memory 502; where:
the memory 502, configured to store computer-executed instructions;
the processor 501, configured to execute the computer-executed instructions stored in the memory to implement the steps performed by the user equipment in the above embodiments. For details, refer to the related descriptions in the previous embodiments of the method.

Or, the processor 501 is configured to execute the computer-executed instructions stored in the memory to implement the steps performed by the network device in the above embodiments. For details, refer to the related descriptions in the previous embodiments of the method.

Optionally, the memory 502 can be either standalone or integrated with the processor 501.

When the memory 502 is set standalone, the device also includes a bus 503 for connecting the memory 502 and the processor 501.

Further, based on the contents described in the above embodiments, an embodiment of the present disclosure also provides a computer readable storage medium, the computer readable storage medium stores computer-executed instructions, and when a processor executes the computer-executed instructions, the steps performed on the user equipment side in the above embodiments are implemented.

Further, based on the contents described in the above embodiments, an embodiment of the present disclosure also provides a computer readable storage medium, the computer readable storage medium stores computer-executed instructions, and when a processor executes the computer-executed instructions, the steps performed on the network device side in the above embodiments are implemented.

Further, based on the contents described in the above embodiments, an embodiment of the present disclosure also provides a computer program product, including a computer program, when the computer program is executed by a processor, the steps performed on the user equipment side as described in the above embodiments are implemented; or the steps performed on the network device side in the above embodiments are implemented.

It should be understood that in the several embodiments provided in the present disclosure, the devices and methods disclosed can be implemented by other means. For example, the device embodiments described above are only for illustrative purposes. For example, the division of the module is only a logical function division, and the actual implementation can have another division. For example, multiple modules can be combined or integrated into another system, or some features can be ignored, or not executed. In addition, the coupling or direct coupling or communication connection between each other shown or discussed may be an indirect coupling or communication connection through some interface, apparatus or module, which may be in electrical, mechanical or other form.

The modules described as separate parts may or may not be physically separate, and the components displayed as modules may or may not be physical units, that is, may be located in one place, or may be distributed to multiple network units. Some or all of the modules can be selected based on the actual needs to realize the purpose of this embodiment solution.

In addition, the functional modules in each embodiment of the present disclosure may be integrated in one processing unit, or each module may exist physically separately, or two or more modules may be integrated in one unit. The unit integrated by the above modules can be implemented either in the form of hardware or in the form of hardware and software functional units.

The integrated modules, implemented in the form of software functional module, can be stored in a computer readable storage medium. The software function module is stored in a storage medium and includes several instructions to enable a computer device (which may be a personal computer, server, or network device, etc.) or processor to perform some of the steps of the method described in the various embodiments of the present disclosure.

It should be understood that the above processor can be a central processing unit (CPU), or other general-purpose processor, or digital signal processor (DSP), application specific integrated circuit (ASIC), etc. A general-purpose processor can be a microprocessor or the processor can be a certain processor, etc. Steps incorporating the methods disclosed in the application may be performed directly by a hardware processor or by a combination of hardware and software modules in the processor.

The memory may include high-speed random access memory (RAM), and may also include nonvolatile memory (NVM), such as at least one disk memory. It can also be a USB disk, mobile hard disk, read-only memory, disk or optical disc.

The bus can be an industry standard architecture (ISA) bus, a peripheral component interconnect (PCI) bus or extended industry standard architecture (EISA) bus, etc. The bus can be divided into address bus, data bus, control bus and so on. For ease of representation, the bus in the drawing attached to the present disclosure is not limited to only one bus or one type of bus.

The above storage medium can be implemented by any type of volatile or non-volatile storage device or a combination thereof, such as static random access memory (SRAM), electrically erasable programmable read only memory (EEPROM), erasable programmable read only memory (EPROM), programmable read only memory (PROM), read only memory (ROM), magnetic memory, flash memory, disk or optical disc. The storage medium can be any available medium that a general-purpose or special-purpose computer can access.

An exemplary storage medium is coupled to a processor so that the processor can read information from the storage medium and write information to the storage medium. Of course, the storage medium can also be part of the processor. The processor and the storage medium can be located in the ASIC. Of course, the processor and the storage medium can also exist as discrete components in the electronic device or a master device.

It may be understood by persons of ordinary skill in the art that all or part of the steps of the embodiments of the above methods may be implemented by the hardware associated with the program instructions. The aforementioned program may be stored in a computer readable storage medium. The program, when executed, performs the steps including embodiments of the above methods; the aforementioned storage medium includes: ROM, RAM, disk or CD and other medium that can store program code.

Finally, it should be noted that the above embodiments are used only to illustrate the technical solution of the present disclosure, and not to limit it. Though the detailed description of the present disclosure is made by reference to the foregoing embodiments, it should be understood by persons of ordinary skill in the art that they may still make modifications to the technical solution described in the foregoing embodiments, or make equivalent substitutions for some or all of the technical features thereof; such modifications or substitutions shall not cause the essence of the corresponding technical solution to deviate from the scope of the technical solution of each embodiment of the present disclosure.

The present disclosure provides an indication information processing method and a device, which can solve a technical problem of how to establish uplink synchronization with a switching target cell when a terminal device handovers from a current cell to the switching target cell.

In a first aspect, an embodiment of the present disclosure provides an indication information processing method, where the method includes: based on indication information, determining a state of a synchronization signal block (SSB), and/or determining a state of a random access resource for uplink synchronization. The PBCH is short for Physical Broadcast Channel.

In some embodiments, the indication information is carried by any one of a physical downlink control channel (PDCCH) order (PDCCH order for short), a group common (GC) PDCCH (GC-PDCCH for short) or a media access control-control entity (MAC-CE).

In some embodiments, the indication information is first indication information;
the based on the indication information, determining the state of the SSB, and/or determining the state of the random access resource for uplink synchronization includes:
based on the first indication information, determining that the state of the SSB is SSB state 1 or SSB state 2.

In some embodiments, a SSB index, a random access preamble index, and a physical random access channel (PRACH) mask index in the PDCCH order are reserved when the state of the SSB is determined to be the SSB state 2.

In some embodiments, the first indication information is of 1 bit.

In some embodiments, the indication information is second indication information;
the based on the indication information, determining the state of the SSB, and/or determining the state of the random access resource for uplink synchronization includes:
based on the second indication information, determining that the state of the random access resource is random access resource state 1 or random access resource state 2.

In some embodiments, the second indication information is of 1 bit.

In some embodiments, the indication information is third indication information;
the based on the indication information, determining the state of the SSB, and/or determining the state of the random access resource for uplink synchronization includes:
based on the third indication information, determining that the state of the SSB is SSB state 1 or SSB state 2, and determining that the state of the random access resource is random access resource state 1 or random access resource state 2.

In some embodiments, the third indication information includes at least three different codepoints, each used to indicate:
the SSB state 1;
the SSB state 2 and the random access resource state 1;
the SSB state 2 and the random access resource state 2.

In some embodiments, the third indication information is of 2 bits.

In a second aspect, an embodiment of the present disclosure provides an indication information processing method, where the method includes:
based on indication information, determining an index or identification information of a bandwidth part (BWP) activated in a switching target cell.

In some embodiments, the indication information is carried by any one of a PDCCH order, a GC-PDCCH, or a MAC-CE.

In some embodiments, the indication information is of 2 bits.

In a third aspect, an embodiment of the present disclosure provides an indication information processing method, where the method includes: based on indication information, determining a frequency point and/or cell identification of a switching target cell.

In some embodiments, the indication information is carried by any one of a PDCCH order, a GC-PDCCH, or a MAC-CE.

In some embodiments, the indication information is of 2 bits.

In a fourth aspect, an embodiment of the present disclosure provides an indication information processing method, where the method includes:
configuring indication information, where the indication information is used by a terminal device to determine a state of a SSB and/or determine a state of a random access resource for uplink synchronization.

In some embodiments, the indication information is carried by any one of a PDCCH order, a GC-PDCCH, or a MAC-CE.

In some embodiments, the indication information is first indication information, and the first indication information is used to indicate that the state of the SSB is SSB state 1 or SSB state 2.

In some embodiments, a SSB index, a random access preamble index, and a PRACH mask index in the PDCCH order are reserved when the state of the SSB is the SSB state 2.

In some embodiments, the first indication information is of 1 bit.

In some embodiments, the indication information is second indication information, where the second indication information is used to indicate that the state of the random access resource is random access resource state 1 or random access resource state 2.

In some embodiments, the second indication information is of 1 bit.

In some embodiments, the indication information is third indication information, where the third indication information is used to indicate that the state of the SSB is SSB state 1 or SSB state 2, and indicate that the state of the random access resource is random access resource state 1 or random access resource state 2.

In some embodiments, the third indication information includes at least three different codepoints, each used to indicate:
the SSB state 1;
the SSB state 2 and the random access resource state 1;
the SSB state 2 and the random access resource state 2.

In some embodiments, the third indication information is of 2 bits.

In a fifth aspect, an embodiment of the present disclosure provides an indication information processing method, where the method includes:
configuring indication information, where the indication information is used to indicate, to a terminal device, an index or identification information of a BWP activated in a switching target cell.

In some embodiments, the indication information is carried by any one of a PDCCH order, a GC-PDCCH, or a MAC-CE.

In some embodiments, the indication information is of 2 bits.

In a sixth aspect, an embodiment of the present disclosure provides an indication information processing method, where the method includes:
configuring indication information, where the indication information is used to indicate, to a terminal device, a frequency point and/or cell identification of a switching target cell.

In some embodiments, the indication information is carried by any one of a PDCCH order, a GC-PDCCH, or a MAC-CE.

In some embodiments, the indication information is of 2 bits.

In a seventh aspect, an embodiment of the present disclosure provides an indication information processing apparatus, where the apparatus includes:
a determination module, configured to: based on indication information, determine a state of a SSB, and/or determine a state of a random access resource for uplink synchronization.

In an eighth aspect, an embodiment of the present disclosure provides an indication information processing apparatus, where the apparatus includes:
a determination module, configured to determine, based on indication information, an index or identification information of a BWP activated in a switching target cell.

In a ninth aspect, an embodiment of the present disclosure provides an indication information processing apparatus, where the apparatus includes:
a determination module, configured to determine, based on indication information, a frequency point and/or cell identification of a switching target cell.

In a tenth aspect, an embodiment of the present disclosure provides an indication information processing apparatus, where the apparatus includes:
a configuration module, configured to configure indication information, where the indication information is used by a terminal device to determine a state of a SSB, and/or a state of a random access resource for uplink synchronization.

In an eleventh aspect, an embodiment of the present disclosure provides an indication information processing apparatus, where the apparatus includes:
a configuration module, configured to configure indication information, where the indication information is used to indicate, to a terminal device, an index or identification information of a BWP activated in a switching target cell.

In a twelfth aspect, an embodiment of the present disclosure provides an indication information processing apparatus, where the apparatus includes:
a configuration module, configured to configure indication information, where the indication information is used to indicate, to a terminal device, a frequency point and/or cell identification of a switching target cell.

In a thirteenth aspect, an embodiment of the present disclosure provides a user equipment including: at least one processor and a memory;
the memory stores computer-executed instructions;
the at least one processor executes the computer-executed instructions stored in the memory to cause the at least one processor to execute the indication information processing method described in the first or second or third aspect.

In a fourteenth aspect, an embodiment of the present disclosure provides a network device including: at least one processor and a memory;
the memory stores computer-executed instructions;
the at least one processor executes the computer-executed instructions stored in the memory to cause the at least one processor to execute the indication information processing method described in the fourth or fifth or sixth aspect.

In a fifteenth aspect, an embodiment of the present disclosure provides a computer readable storage medium, where the computer readable storage medium stores computer-executed instructions, when a computer executes the computer-executed instructions, the indication information processing method described in the first or second or third aspect is implemented;
or, when the computer executes the computer-executed instructions, the indication information processing method described in the fourth or fifth or sixth aspect is implemented.

In a sixteenth aspect, an embodiment of the present disclosure provides a computer program product, including a computer program, where when the computer program is executed by a computer, the indication information processing method described in the first or second or third aspect is implemented, or, the indication information processing method described in the fourth or fifth or sixth aspect is implemented.

In a seventeenth aspect, an embodiment of the present disclosure provides a chip, including: a processor and a memory; the memory is configured to store executable instructions of the processor; where the processor is configured to implement the indication information processing method described in the first or second or third aspect by executing the executable instructions;
or, the processor is configured to implement the indication information processing method described in the fourth or fifth or sixth aspect by executing the executable instructions.

Based on an indication information processing method and the device provided by the present disclosure, a terminal device can determine a state of SSB and/or a state of a random access resource, so as to help the terminal device to cope with various uplink synchronization scenarios.

1. An indication information processing method, wherein the method comprises:
based on indication information, determining a state of a synchronization signal block (SSB), and/or determining a state of a random access resource for uplink synchronization.

2. The method according to claim 1, wherein the indication information is carried by any one of a physical downlink control channel (PDCCH) order, a group common physical downlink control channel (GC-PDCCH) or a media access control-control entity (MAC-CE).

3. The method according to claim 1, wherein the indication information is first indication information;
the based on the indication information, determining the state of the SSB, and/or determining the state of the random access resource for uplink synchronization comprises:
based on the first indication information, determining that the state of the SSB is SSB state 1 or SSB state 2.

4. The method according to claim 3, wherein,
a SSB index, a random access preamble index, and a physical random access channel PRACH mask index in the PDCCH order are reserved in a case that the state of the SSB is determined to be the SSB state 2.

5. The method according to claim 3, wherein the first indication information is of 1 bit.

6. The method according to claim 1, wherein the indication information is second indication information;
the based on the indication information, determining the state of the SSB, and/or determining the state of the random access resource for uplink synchronization comprises:
based on the second indication information, determining that the state of the random access resource is random access resource state 1 or random access resource state 2.

7. The method according to claim 6, wherein the second indication information is of 1 bit.

8. (canceled)

9. (canceled)

10. (canceled)

11. An indication information processing method, wherein the method comprises:
based on indication information, determining an index or identification information of a bandwidth part (BWP) activated in a switching target cell.

12. The method according to claim 11, wherein the indication information is carried by any one of a physical downlink control channel (PDCCH) order, a group common physical downlink control channel (GC-PDCCH) or a media access control-control entity (MAC-CE).

13. (canceled)

14. (canceled)

15. (canceled)

16. (canceled)

17. An indication information processing method, wherein the method comprises:
configuring indication information, wherein the indication information is used by a terminal device to determine a state of a synchronization signal block (SSB) and/or determine a state of a random access resource for uplink synchronization.

18. The method according to claim 17, wherein the indication information is carried by any one of a physical downlink control channel (PDCCH) order, a group common physical downlink control channel (GC-PDCCH) or a media access control-control entity (MAC-CE).

19. The method according to claim 17, wherein the indication information is first indication information, and the first indication information is used to indicate that the state of the SSB is SSB state 1 or SSB state 2.

20. The method according to claim 19, wherein,
a SSB index, a random access preamble index, and a PRACH mask index in the PDCCH order are reserved in a case that the state of the SSB is the SSB state 2.

21. The method according to claim 19, wherein the first indication information is of 1 bit.

22. The method according to claim 17, wherein the indication information is second indication information, wherein the second indication information is used to indicate that the state of the random access resource is random access resource state 1 or random access resource state 2.

23. The method according to claim 22, wherein the second indication information is of 1 bit.

24. (canceled)

25. (canceled)

26. The method according to claim 17, wherein the third indication information is of 2 bits.

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. A non-transitory computer readable storage medium, wherein the computer readable storage medium stores computer-executed instructions, and in a case that a computer executes the computer-executed instructions, the indication information processing method according to claim 1 is implemented.

42. (canceled)
